(19) United States
(12) Patent Application Publication
(10) Pub. No.: US 2026/0044362 A1
(43) Pub. Date: Feb. 12, 2026

(54) TOPOLOGY-AWARE MULTI-HOST MODEL SERVING SYSTEM WITH MIRRORED LOCAL IMAGE REGISTRIES

(71) Applicant: Red Hat, Inc., Raleigh, NC (US)

(72) Inventor: Yuan Tang, Indianapolis, IN (US)

(21) Appl. No.: 18/965,636

(22) Filed: Dec. 2, 2024

Related U.S. Application Data
(60) Provisional application No. 63/680,418, filed on Aug. 7, 2024.

(51) Int. Cl. G06F 9/455

(52) U.S. Cl. CPC G06F 9/45558; G06F 2009/45595

(57) ABSTRACT

Model server replicas are initialized on a set of first host machines. The model server replicas are each configured to execute an instance of a machine-learned model by obtaining first model image partitions. Each model image partition stores a separate portion of the model. Initializer nodes are executed on a set of second host machines that are selected based on a geographic location of the set of first host machines. Each of the initializer nodes comprises a local image registry mirror provisioned with the model image partitions. Each of the model server replicas are configured such that the model server replica pulls the model image partitions from the local image registry mirror of an initializer node.

### BACKGROUND

This application claims the benefit of, and priority based on, 35 U.S.C. § 119 to U.S. Provisional Application No. 63/670,715, filed Jul. 12, 2024, which is incorporated herein by reference in its entirety.

### BACKGROUND

Containers are a form of virtualization that enables applications to run in isolated environments, ensuring consistency across multiple types of environments (e.g., development, testing, production, etc.). Unlike traditional virtual machines, which generally require a complete operating system instance for each application, containers share the host system's kernel and run as isolated processes. This approach significantly reduces overhead and allows for faster startup times. A key feature of containers is their use of layers, where each layer represents a file system change, such as adding a file or installing a package. These layers are stacked and shared across containers, enabling efficient storage and minimizing redundancy.

### SUMMARY

Implementations described herein provide for a topology-aware multi-host model serving system with mirrored local image registries. More specifically, model server replicas can be initialized on replica host machines. The model server replicas are each configured to execute an instance of a machine-learned model by obtaining model image partitions from existing host machines. Instead, initializer nodes are executed on node host machines that are selected based on a geographic location of the replica host machines. The initializer nodes include local image registry mirrors provisioned with the model image partitions. A configuration of each of the model server replica is modified such that the model server replica obtains the model image partitions from the local image registry mirror of an initializer node.

In one implementation, a method is provided. The method includes initializing, by a computing system comprising one or more computing devices, a plurality of model server replicas on a set of first host machines, wherein the plurality of model server replicas are each configured to execute an instance of a first machine-learned model by obtaining a plurality of first model image partitions, wherein each first model image partition stores a separate portion of the first machine-learned model. The method further includes executing a plurality of initializer nodes on a set of second host machines, wherein the set of second host machines is selected based on a geographic location of the set of first host machines, wherein each of the plurality of initializer nodes comprises a local image registry mirror provisioned with at least one of the plurality of first model image partitions. The method further includes, for each of the plurality of model server replicas, configuring the model server replica such that the model server replica obtains the plurality of first model image partitions from the local image registry mirror of one or more initializer nodes of the plurality of initializer nodes.

In another implementation, a computing system is provided. The computing system includes a memory and one or more processor devices coupled to the memory. The one or more processor devices are to initialize a plurality of model server replicas on a set of first host machines, wherein the plurality of model server replicas are each configured to execute an instance of a first machine-learned model by obtaining a plurality of first model image partitions, wherein each first model image partition stores a separate portion of the first machine-learned model. The one or more processor devices are further to execute a plurality of initializer nodes on a set of second host machines, wherein the set of second host machines is selected based on a geographic location of the set of first host machines, wherein each of the plurality of initializer nodes comprises a local image registry mirror provisioned with at least one of the plurality of first model image partitions. The one or more processor devices are further to, for each of the plurality of model server replicas, configure the model server replica such that the model server replica obtains the plurality of first model image partitions from the local image registry mirror of one or more initializer nodes of the plurality of initializer nodes.

In another implementation, a non-transitory computer-readable storage medium is provided. The non-transitory computer-readable storage medium includes executable instructions configured to cause one or more computing devices to initialize a plurality of model server replicas on a set of first host machines, wherein the plurality of model server replicas are each configured to execute an instance of a first machine-learned model by obtaining a plurality of first model image partitions, wherein each first model image partition stores a separate portion of the first machine-learned model, and wherein the plurality of second host machines each host the plurality of first model image partitions. The one or more computing devices are further to execute a plurality of initializer nodes on a set of second host machines, wherein the set of second host machines is selected based on a geographic location of the set of first host machines, wherein each of the plurality of initializer nodes comprises a local image registry mirror provisioned with at least one of the plurality of first model image partitions. The one or more computing devices are further to, for each of the plurality of model server replicas, configure the model server replica such that the model server replica obtains the plurality of first model image partitions from the local image registry mirror of one or more initializer nodes of the plurality of initializer nodes.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system for topology-aware multi-host model serving system with mirrored local image registries according to some implementations of the present disclosure.

FIG. 2A illustrates an example geographic rack-level distribution of model server replicas provisioned by a rack-level node host server according to some implementations of the present disclosure.

FIG. 2B illustrates an example geographic Availability Zone (AZ)-level distribution of model server replicas provisioned by an AZ-level node host server according to some implementations of the present disclosure.

FIG. 3 is a flowchart illustrating operations performed by the computing system of FIG. 1 to implement a topology-aware multi-host model serving system with mirrored local image registries, according to one example.

FIG. 4 is a block diagram of the computing system of FIG. 1 for a topology-aware multi-host model serving system with mirrored local image registries, according to one example.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Machine learning is leveraged across a wide variety of industries and use-cases. For example, machine-learned models can be used to perform object recognition, pilot software-defined vehicles, identify malicious actors, predict the occurrence of events, etc. However, as the capabilities of machine-learned models have increased, their corresponding computational costs have increased as well. Machine-learned models are famously expensive to train and use at inference. In addition, the infrastructure used to support such models is also computationally expensive. For example, storing large machine-learned models, such as Large Language Models (LLMs), can require substantial amounts of bandwidth and memory. When models are updated via training iterations, updated models must be transmitted over networks to each device that uses an instance of the model. As such, recent attempts have been made to reduce the computational complexity of both machine-learned models and the infrastructure used to implement such models.

One such attempt stores machine-learned models as container images in an effort to reduce the computational costs of storing and loading machine-learned models. Storing a model as a container image provides a number of benefits inherent to containerization platforms. For example, machine-learned models stored as container images can be indexed and stored to a container registry, which in turn enables local caching of the model. Because container images are immutable, storing models as container images also provides “immutability” to models, which is important in ensuring model output consistency as models are changed frequently with additional training or fine-tuning iterations.

Another benefit provided by model containerization is that scaling containerized models is made easier. When containerized, models can be easily distributed to worker nodes, or “model server replicas”, as needed based on demand. For example, when using a container orchestration system like Kubernetes®, if a model container image is obtained on a Kubernetes “node” (e.g., a physical or virtual machine), all Kubernetes “pods” (e.g., groupings of container(s)) executed on the node will have access to the obtained image without need to “re-obtain” the image, thus substantially reducing computational resource expenditure (e.g., bandwidth, memory, etc.).

As described herein, a “model server” refers to a unit of software instructions that hosts, manages, and serves machine learning models to provide predictions or inferences in response to requests. A “model server replica” refers to an individual instance of a model server that is running as part of a scalable deployment. Each model server replica can host the same trained machine learning model and can serve predictions independently, enabling the system to handle higher traffic loads, improve availability, and ensure fault tolerance. For example, assume that an organization provides generative text services (e.g., essay writing, homework completion, etc.) using instances of an LLM. During periods of high demand (e.g., when students come home from school), model server replicas can be dynamically instantiated to handle the demand, and then de-instantiated as demand decreases. Once instantiated, each of the model server replicas can obtain a container image storing the LLM from the container image registry and then “serve” the model.

Generally, container images are “pulled” or otherwise obtained from a centralized container image registry that stores and indexes container images for a containerization system. Such container image registries are generally not implemented using a single set of physical computing resources. Rather, the container image registry is distributed across a number of physical devices located in different geographic locations, analogously to a Content Delivery Network (CDN). For example, a container image registry may actually be implemented as two “local image registry mirrors” that both store complete copies of the container image registry. One may be placed on the west coast of the United States while the other is placed on the east coast to improve latency and efficiency.

Cutting edge implementations of container image registries will often distribute storage of container images across a set of discrete computing and/or storage devices for efficiency purposes. In other words, a local image registry mirror may refer to a plurality of computing and storage devices that collectively store the container images included in the local image registry mirror. Such implementations will also partition larger container images to further improve efficiency. Due to the prohibitively large size of current machine-learned models (e.g., LLMs, Large Foundational Models (LFMs), etc.), this usually means that a container image storing a machine-learned model will be partitioned across a set of computing or storage devices when stored to a container image registry.

However, the systems that dynamically scale model server replicas are not aware of the architecture of the container image registries from which the container images are obtained, and vice-versa. As such, a container image registry might partition a machine-learned model container image and store the partitions across a geographically distributed set of storage devices even if the container image is regularly obtained by model server replicas. Due to the distributed nature of container image registries described above, multiple model server replicas obtaining model container images from local image registry mirrors can be prohibitively expensive.

For example, assume that a LLM is stored as a container image and the container image is stored to a container image registry. Due to the size of the container image, the container image registry can partition the container image and store the partitions across storage devices located in California, New York, and Seattle. Further assume that a model server predicts a substantial increase in demand and instantiates a large number of model server replicas. If each model server replica obtains the model container image from the container image registry, each of the storage devices located in California, New York, and Seattle would be instructed to transmit their respective partitions to each of the model server replicas. In turn, transmitting the model image partitions across such a large area can be prohibitively expensive and can introduce a prohibitive degree of latency.

Accordingly, implementations described herein propose an efficient topology-aware multi-host model serving system with mirrored local image registries. More specifically, a computing system can initialize a plurality of model server replicas on a set of replica host machines. For example, assume that the computing system is associated with an organization that fulfills requests by serving machine-learned models (e.g., a text generation service, etc.). Further assume that the organization receives an unexpected spike in requests. In response, the computing system can initiate the plurality of model server replicas on the set of replica host machines to handle the unexpected spike in requests.

The model server replicas can each serve an instance of a particular machine-learned model. To do so, each model server replica can be configured to obtain a set of model image partitions from a set of partition host machines. The model image partitions can be partitions of a container image that stores the machine-learned model. More specifically, given that the size of a container image storing a machine-learned model is very large, the container image is likely partitioned and stored across a set of geographically distributed storage devices (e.g., located in New York, Seattle, Arizona, etc.). Each of the image partitions can store a corresponding portion of the machine-learned model.

Each of the model server replicas can be configured to obtain the model image partitions from a set of image host machines. To follow the previous example, if an image host machine storing all of the partitions is located in Arizona, and a replica host machine is located in New York, the replica host machine would instruct the Arizona-based image host machine to transmit the model image partitions to the New York-based replica host machine. For another example, if half of the model image partitions were stored at the Arizona-based machine and the other half of the model image partitions are stored at a Seattle-based machine, the replica host machine would instruct the Arizona-based and Seattle-based image host machines to transmit the model image partitions. In either instance, the latency and network resource cost associated with such transmissions can be prohibitively expensive.

As such, the computing system can execute a plurality of initializer nodes on a set of node host machines. The set of node host machines can be selected based on the geographic location of the set of replica host machines. For example, assume that the replica host machines are located on the west coast of the United States and the set of image host machines are located on the east coast of the United States. Each of the initializer nodes can include a local image registry mirror. The local image registry mirror of each initializer node can include each partition of the container image storing the machine-learned model.

To minimize a distance between both the replica host machines and the image host machines, the computing system can select a set of node host machines at a location between the replica host machines and the image host machines, such as Texas. By doing so, the computing system can minimize latency between model updates communicated to the node host machines from the image host machines, and can also minimize latency to deliver the container image partitions to the requesting replica host machines.

Once the initializer nodes are executed, the computing system can modify the configuration of each of the model server replicas. The computing system can modify the configuration such that the model server replica obtains the model image partitions from the local image registry mirror of one of the initializer nodes, rather than obtaining from the image host machines. For example, assume that, before the initializer nodes are executed, a model server replica executed on a replica host machine located in New York is configured to obtain the model image partitions from an existing container image registry located in San Francisco. Further assume that an initializer node is executed on a node host machine located in New Jersey. The computing system can modify the configuration of the model server replica such that the model server replica obtains the model image partitions from the local image registry mirror of the New Jersey initializer node rather than obtaining from the local image registry mirror located in San Francisco.

Aspects of the present disclosure provide a number of technical effects and benefits. As one example technical effect and benefit, implementations described herein reduce bandwidth and network resource expenditure. To follow the previous example above, by modifying the configuration of the model server replica such that the New York-based model server replica obtains the model image partitions from the local image registry mirror of the New Jersey initializer node rather than obtaining from the local image registry mirror located in San Francisco, implementations described herein can substantially reduce latency and network resource utilization.

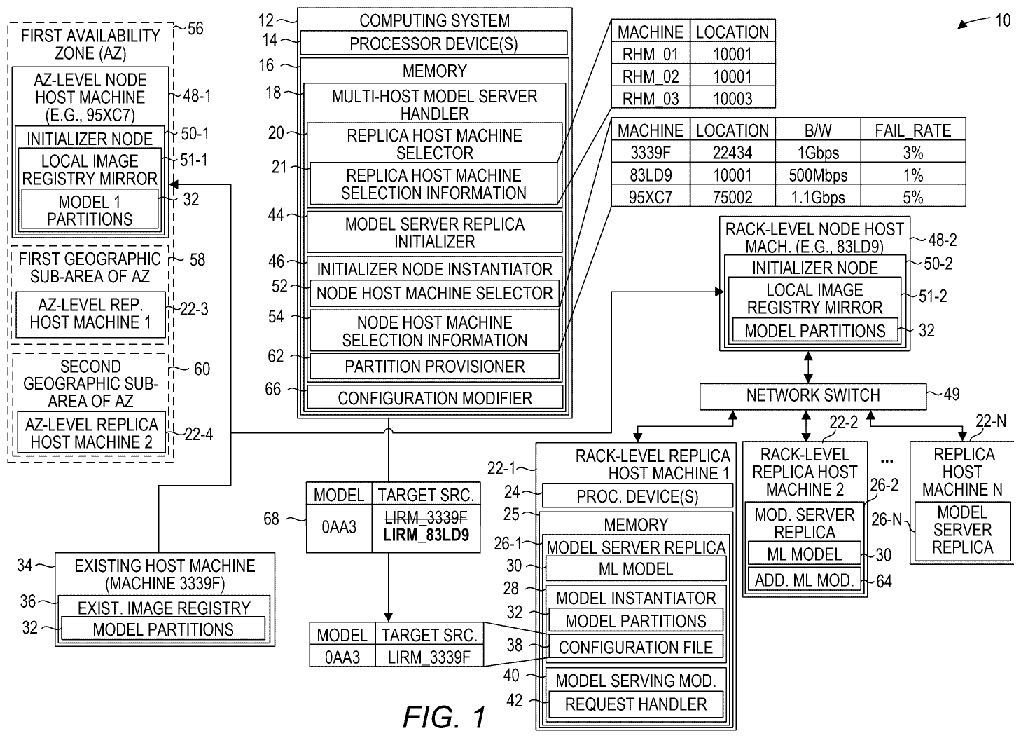

FIG. 1 is a block diagram of a computing system for topology-aware multi-host model serving system with mirrored local image registries according to some implementations of the present disclosure. FIG. 1 depicts an execution environment 10 that includes a computing system 12. The computing system 12 includes processor device(s) 14 and a memory 16. The computing system 12 can operate in a quantum execution environment and/or operate using classical computing principles and/or quantum computing principles. The computing system 12 can be any type or manner of computing device or network node, and can include physical computing device(s) (e.g., Central Processing Units (CPUs), Graphics Processing Units (GPUs), memory, accelerators, virtualized device(s) or service(s), etc. For example, the computing system 12 can be a virtualized node within a cloud-based computing environment that has indirect access to computing resources through a virtualization layer.

The processor device(s) 14 of the computing system 12 may include any computing or electronic device capable of executing software instructions to implement the functionality described herein. The memory 16 of the computing system 12 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The execution environment 10 can refer to a logical grouping, or clustering, of computing systems, devices, and/or resources. More specifically, the execution environment 10 is an environment in which a number of separate devices and/or systems share resources (e.g., hardware resources, compute cycles, services, etc.) via a central management framework that enforces consistent configuration and policies. It should be noted that the execution environment 10 can include any type or manner of computing device or system. For example, in some implementations, the execution environment 10 can include a number of computing systems and classical computing systems.

The memory 16 of the computing system 12 can include a multi-host model server handler 18. The multi-host model server handler 18 can dynamically instantiate and/or de-instantiate model server replicas based on demand. To do so, the multi-host model server handler can select replica host machines upon which model server replicas can be instantiated, configure model server replicas to obtain model image partitions from specific hosts, and/or perform other operations to increase the efficiency of model server replicas and supporting infrastructure.

In addition, the multi-host model server handler 18 can start a launcher process, collect a list of hosts where the model image partitions are stored through a query to an image registry, start a number of warm-up initializer nodes that are geographically close to both the group of model image partitions and the hosts of the model server replicas, etc. For example, the multi-host model server handler 18 can start an image registry local mirror on each of the initializer nodes that are started by the launcher process. Each local mirror can include the model image partitions that will be served by the top-K nearest neighbor model service replica hosts, and each model server replica located on different hosts can obtain model image partition images from the nearest image registry local mirror that are located in warm-up initializer nodes.

To do so, the multi-host model server handler 18 can include a replica host machine selector 20. As described herein, a “replica host machine” can refer to a set of physical and/or virtualized computing resources that can be utilized to implement or otherwise “host” a model server replica. A model server replica can include an individual instance of a model server that is running as part of a scalable deployment. Each model server replica can host the same trained machine learning model and can process requests that leverage the model.

The replica host machine selector 20 can select replica host machines 22-1-22-N (generally, replica host machines 22). In some implementations, the replica host machine selector 20 can select the replica host machines 22 based on a location of the replica host machines 22, the location of requestor(s) associated with increased demand, etc. For example, if an increase in demand for model-serving services is identified (or predicted), the multi-host model server handler 18 can attempt to identify a location associated with the increase in demand if the requests are originating from a single entity or geographically proximate group of entities. If identified, the multi-host model server handler 18 can select the replica host machines 22 that are geographically proximate to the requesting entities.

In some implementations, the replica host machine selector 20 can select the replica host machines 22 based on replica host machine selection information 21. The replica host machine selection information 21 can describe various characteristics of the replica host machines 22, such as a computational capacity (e.g., provisioned and/or available computing resources, bandwidth capacity, a file size associated with model partitions to be provided, etc.), location, estimated latency, reliability (e.g., frequency of recorded failure, etc.), and the like. In some implementations, the replica host machine selection information 21 can be generated (or modified) following selection of the replica host machines 22 to indicate the location of the selected replica host machines 22. To follow the depicted example, the replica host machine selection information 21 can include a ZIP code (or other locational information, such as coordinates, etc.) indicating the location of the selected machine.

In some implementations, the replica host machines 22 can include “rack-level” replica host machines, such as replica host machines 22-1 and 22-2. Additionally, or alternatively, in some implementations, the replica host machines 22 can include “Availability Zone (AZ)-level” replica host machines, such as replica host machine 22-3. The differences between rack-level and AZ-level replica host machines will be discussed subsequently.

The replica host machines 22, such as the replica host machine 22-1, can include processor device(s) 24 and a memory 25 as described with regards to the processor device(s) 14 and the memory 16 of the computing system 12, respectively. The memories of the replica host machines 22 can include a plurality of model server replicas 26-1-26-N (generally, model server replicas 26). The model server replica 26-1 can include a model instantiator 28. The model instantiator 28 can instantiate an instance of a machine-learned model 30 so that the model can be served by the replica host machine 22-1.

The machine-learned model 30 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models, etc.).

To instantiate the machine-learned model 30, the model instantiator 28 can obtain a plurality of model image partitions 32. The model image partitions 32 can include multiple partitions of a container image, and each of the partitions can store a corresponding portion (e.g., layer, set of layers, metadata, etc.) of the machine-learned model 30. Once the model image partitions 32 are obtained by the model instantiator 28, the model instantiator 28 can reconstruct the container image from the separate model image partitions 32 and extract the machine-learned model 30 from the instantiated container image (or otherwise launch the container image to access the model).

The model instantiator 28 can “pull” or otherwise obtain the model image partitions 32 from an existing host machine 34. More specifically, the existing host machine 34 can be a host for an existing image registry 36. The existing image registry 36 can store at least some of the model image partitions 32 pulled by the replica host machine 22-1. The replica host machine 22-1 can send a request for the model image partitions 32 (either directly to the existing host machine 34 or indirectly via an intermediary orchestrating service, such as a container orchestrator). In response, the existing image registry 36 can transmit the model image partitions 32 to the replica host machine 22-1. If the existing image registry 36 only includes some of the model image partitions 32, and other partitions of the model image partitions 32 are stored to a different existing image registry (not illustrated), the process described above can be repeated to obtain the remaining model image partitions 32 from the different existing image registry.

The model instantiator 28 can obtain the model image partitions 32 based on a configuration file 38 of the model server replica 26-1. More specifically, the configuration file 38 of the model server replica 26-1 can define a configuration of the model server replica 26-1, and the configuration of the model server replica 26-1 can specify a particular image registry from which the model server replica 26-1 is to obtain model image partitions. For example, the configuration file 38 can specify that the model image partitions 32 should be obtained specifically from the existing image registry 36 of the existing host machine 34.

The model server replica 26-1 can include a model serving module 40. The model serving module 40 can handle operations related to handling model service requests, such as receiving requests, fulfilling requests, returning requested outputs to requestors, etc. For example, the model serving module 40 can include a request handler 42. The request handler 42 can receive a request for the machine-learned model 30 (e.g., a request to process an attached input with the machine-learned model 30, a prompt for the machine-learned model 30, a requested output from the machine-learned model 30, etc.).

Returning to the computing system 12, the multi-host model server handler 18 can include a model server replica initializer 44. The model server replica initializer 44 can initialize the model server replicas 26 across the replica host machines 22.

The multi-host model server handler 18 can include an initializer node instantiator 46. The initializer node instantiator 46 can select a plurality of node host machines 48-1-48-N (generally, node host machines 48) upon which a plurality of initializer nodes 50-1-50-N (generally, initializer nodes 50) can be instantiated. As described herein, an “initializer node” refers to a unit of software instructions that implements a local image registry mirror. Initializer nodes can serve model image partitions to model server replicas. As such, the initializer nodes 50 can be placed on the node host machines 48 that are physically proximate to the replica host machines 22 used to implement the model server replicas 26.

The initializer nodes 50 can each include a local image registry mirror 51-1-51-N (generally, local image registry mirrors 51). Each of the local image registry mirrors 51 can provide the same functionality as described with regards to the existing image registry 36 (e.g., providing model image partitions to requesting model server replicas). As such, by instantiating an initializer node 50 on a node host machine 48 that is located at the same geographic location as a corresponding rack-level replica host machine 22 that hosts the model server replica 26 served by the initializer node 50, the multi-host model server handler 182 can substantially reduce latency and network resource utilization.

To instantiate the initializer nodes 50, the initializer node instantiator 46 can include a node host machine selector 52. The node host machine selector 52 can select the set of node host machines 48 upon which to instantiate the initializer nodes 50. The node host machine selector 52 can select the set of node host machines 48 based on node host machine selection information 54. The node host machine selection information 54 can describe characteristics of the node host machines 48, such as computational capacity, estimated latency, location, allocated resources, etc.

In some implementations, the node host machine selector 52 can select the node host machines 48 based on the geographic location of the replica host machines 22. The manner in which the geographic location of the replica host machines 22 is evaluated is based on whether the replica host machines 22 are rack-level replica host machines or AZ-level host machines. A set of “rack-level” replica host machines refers to a set of machines each connected to the same network switch. For example, two local machines may be considered rack-level if they are connected to the same network switch located in the same physical room. For another example, machines located in two separate buildings may be considered rack-level machines if they are connected to the same network switch on an organization's campus network. Any “level” of switch (i.e., hierarchical placement of the switch within an overarching network architecture) can be used when determining whether two machines are rack-level machines to each other.

An “AZ-level” replica host machine refers to replica host machines located within the same AZ (i.e., availability zone). An AZ is a distinct, isolated location within a cloud provider's region, designed to provide high availability by hosting infrastructure and services independently. A availability zone generally includes its own allocated resources (e.g., power, networking resources, compute resources, etc.) AZs can span multiple geographic locations. For example, an AZ may represent a geographic area the size of a US state.

The initializer nodes 50 are instantiated for specific replica host machines of the replica host machines 22. As such, the node host machine selector 52 can determine if the replica host machines 22 are distributed at the rack-level or the AZ-level when selecting a corresponding machine of the node host machines 48. For example, assume that the node host machine selector 52 is selecting a node host machine 48 to host an initializer node 50 that will serve a subset of model server replicas 26 (not illustrated). If the subset of model server replicas 26 is distributed at a rack-level, the node host machine selector 52 can select a rack-level node host machine 48-2 that is also connected to a same network switch 49 as the subset of model server replicas 26. If a node host machine connected to the same network switch is not available, the node host machine selector 52 can select an AZ-level node host machine 48-1 that is located closest to the location of the model server replicas 26. By placing the initializer node on the same network infrastructure (e.g., network switch) as the rack-level replica host machines, implementations described herein enable the initializer node to provision model image partitions over local networks rather than internet-based Wide Area Networks (WANs). In turn, utilizing local networks can practically eliminate latency and substantially reduce network resource utilization.

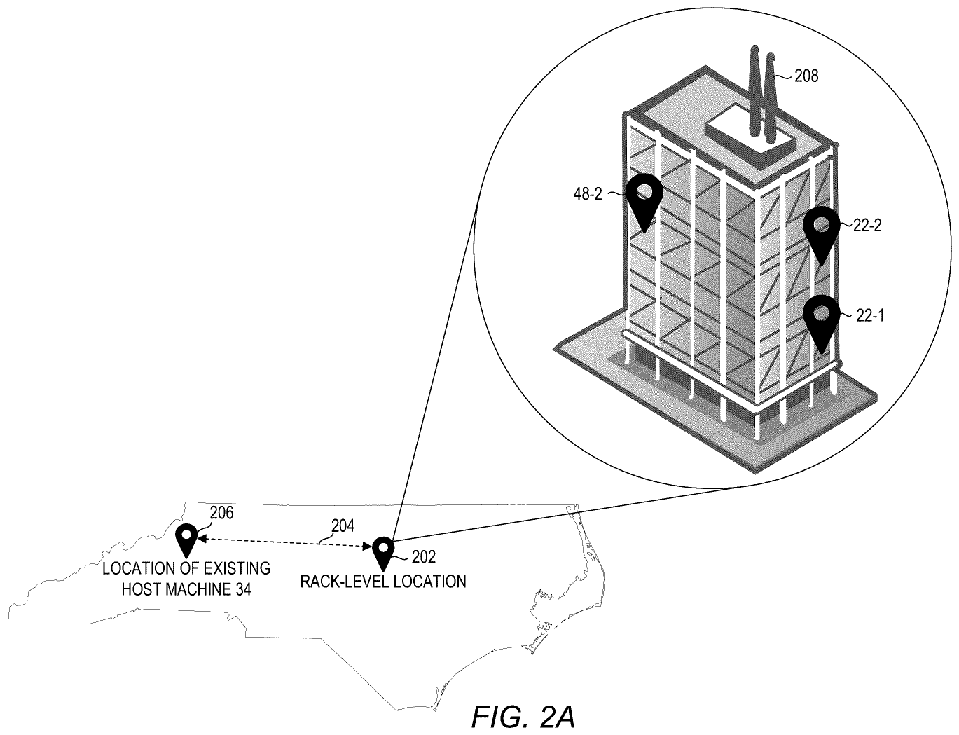

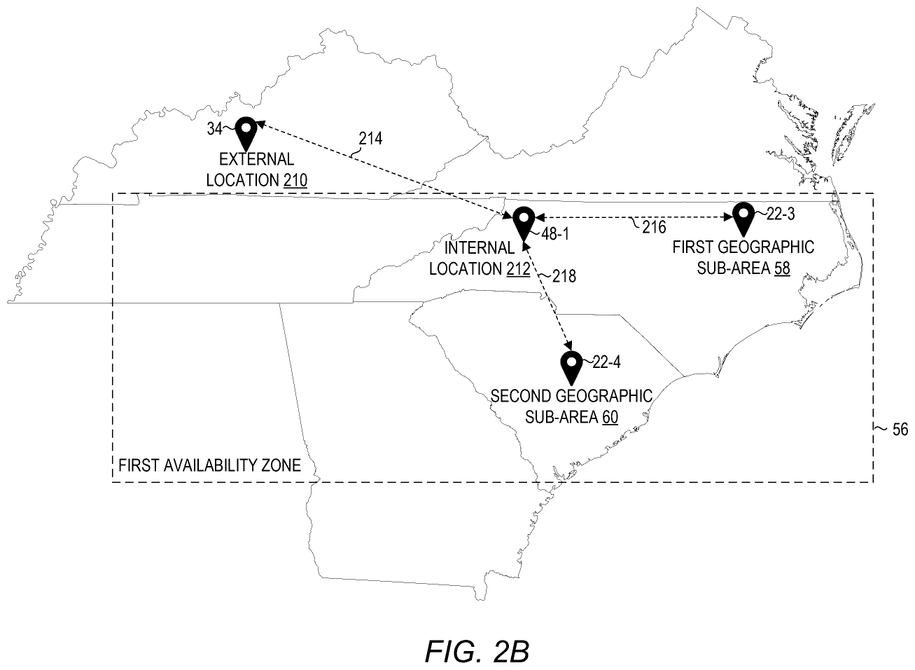

For a more specific example, turning to FIG. 2A, FIG. 2A illustrates an example geographic rack-level distribution of model server replicas provisioned by a rack-level node host server according to some implementations of the present disclosure. FIG. 2A will be discussed in conjunction with FIG. 1. More specifically, a rack-level location 202 can be located a particular distance 204 from an existing host machine location 206 at which the existing host machine 34 is located. As described previously, the existing host machine 34 can represent a host machine that implements an existing image registry 36 that is currently configured to provide the model image partitions 32 to the model server replicas 26. Placing the rack-level node host machine 48-2 at the rack-level can substantially decrease latency and network resource utilization. As such, the distance 204 between the existing host machine location 206 and the rack-level location 202 can be relatively distant while still providing substantial performance improvements.

Rack-level replica host machines 22-1 and 22-2 can be placed at the rack-level location 202. To follow the depicted example, assume that an office building 208 is located at the rack-level location 202. One area of the office building 208 can include the rack-level replica host machine 22-1. Another area of the office building 208 can include the rack-level replica host machine 22-2. Yet another area of the office building 208 can include the rack-level node host machine 48-2. The rack-level node host machine 48-2 can receive the model image partitions 32 from the existing host machine 34. The rack-level node host machine 48-2 can then provide the model image partitions 32 to the rack-level replica host machines 22-1 and 22-2 via the network switch 49.

In some implementations, the rack-level node host machine 48-2 may be located in the same physical area as the rack-level replica host machines 22-1 and 22-2. For example, if the rack-level replica host machines 22-1 and 22-2 are located in the same server room, the rack-level node host machine 48-2 may be selected from a list of machines located in the same room. Alternatively, in some implementations, the rack-level node host machine 48-2 may be located in a different room, building, campus, or geographic area, as long as the rack-level node host machine 48-2 is connected to the same network switch 49 as the rack-level replica host machines 22-1 and 22-2.

Returning to FIG. 1, if replica host machines 22 are not connected to a same network switch, the node host machine selector 52 can select a node host machine at the AZ-level if the replica host machines 22 are located within a same AZ 56. An AZ can include multiple geographic areas or sub-areas. For example, the AZ-level replica host machine 22-3 can be located within a first geographic sub-area 58 (e.g., a first county, state, city, town, building, etc.) of the AZ 56 while a second AZ-level replica host machine 22-4 is located within a second geographic sub-area 60 of the AZ 56. More specifically, if the subset of model server replicas 26 is distributed at an AZ-level, the node host machine selector 52 can select a node host machine 48 that is located between the existing host machines that currently host the model image partitions 32 and the replica host machines 22.

For a more specific example, turning to FIG. 2B, FIG. 2B illustrates an example geographic AZ-level distribution of model server replicas provisioned by an AZ-level node host server according to some implementations of the present disclosure. FIG. 2B will be discussed in conjunction with FIGS. 1 and 2A. More specifically, AZ-level replica host machine 22-3 and AZ-level replica host machine 22-4 can be located within the same AZ 56. The AZ-level replica host machine 22-3 can be located within a first geographic sub-area 58 of the AZ 56. The AZ-level replica host machine 22-4 can be located within the second geographic sub-area 58 of the AZ 56. The existing host machine 34 can be located at an external location 210 that is external to the AZ 56. However, in some implementations, the existing host machine 34 may be located at a location within the AZ 56.

The AZ-level node host machine 48-1 can be located at an internal location 212. The AZ-level node host machine 48-1 can be selected to host the initializer node 50-1 based on the distances between the internal location 212, the external location 210, and the first and second geographic sub-areas 58 and 60. For example, to evaluate the AZ-level node host machine 48-1, the node host machine selector 52 can calculate a first distance 214 between the internal location 212 and the external location 210. The node host machine selector 52 can calculate a second distance 216 between the internal location 212 and the first geographic sub-area 58 (or the location of the AZ-level replica host machine 22-3 within the first geographic sub-area 58). The node host machine selector 52 can calculate a third distance 218 between the internal location 212 and the second geographic sub-area 60. The node host machine selector 52 can then select the AZ-level node host machine 48-1 based on the distances 214, 216, and 218.

In some implementations, the node host machine selector 52 can select an AZ-level node host machine that minimizes a sum of the distances 214, 216, and 218. Additionally, or alternatively, in some implementations, the node host machine selector 52 can select an AZ-level node host machine that minimizes differences between the distances 214, 216, and 218 (or otherwise attempts to make the distances equidistant).

Returning to FIG. 1, based on the criteria described above, the node host machine selector 52 can select one or more host machines 48 upon which to execute the initializer nodes 50. As described previously, the node host machine selector 52 can select AZ-level and/or rack-level host machines based on the distribution of the replica host machines 22. To follow the depicted example, the node host machine selector 52 can select the AZ-level node host machine 48-1 to host the initializer node 50-1. The initializer node 50-1 can serve model image partitions to AZ-level replica host machines 22-3 and 22-4. Similarly, the node host machine selector 52 can select the rack-level node host machine 48-2 to host the initializer node 50-2. The initializer node 50-2 can serve model image partitions to rack-level replica host machines 22-1 and 22-2.

The initializer node instantiator 46 can include a partition provisioner 62. Once the initializer node instantiator 46 instantiates the initializer nodes 50 on the selected node host machines 48, the partition provisioner 62 can provision the initializer nodes with the model image partitions 32. The partition provisioner 62 can do so based on the model(s) being served by the model server replicas 26. For example, the rack-level replica host machine 22-1 serves the machine-learned model 30. The rack-level replica host machine 22-1 serves both the machine-learned model 30 and an additional machine-learned model 64. As such, the partition provisioner 62 can provision the initializer node 50-2 hosted on the rack-level node host machine 48-2 with the model image partitions 32 for the machine-learned model 30 and additional model image partitions for the additional machine-learned model 64 (not illustrated).

The multi-host model server handler 18 can include a configuration modifier 66. The configuration modifier 66 can modify the configuration files of the model server replicas 26 so that the model server replicas 26 obtain the model image partitions 32 from the local image registry mirror of one or more initializer nodes of the plurality of initializer nodes. To follow the depicted example, assume that the configuration file 38 for the model server replica 26-1 specifies the existing host machine 34 as a target source for the model partitions 38 and any associated updates. The configuration modifier 66 can generate configuration modifications 68 and send the configuration modifications 68 to the model server replica 26-1. The configuration modifications 68 can modify the configuration file 38 to replace the existing host machine 34 (e.g., machine ID LIRM_3339F) with the rack-level node host machine 48-2 (e.g., machine ID LIRM_83LD9) as the target source for the model partitions 32.

It should be noted that the configuration modifier 66 can perform operations other than configuration modification related tasks to cause the rack-level replica host machine 22-1 to utilize the rack-level node host machine 48-2. For example, the configuration modifier 66 may simply instruct the rack-level replica host machine 22-1 to utilize the rack-level node host machine 48-2, and in response, the rack-level replica host machine 22-1 can modify the configuration file 38 itself to do so. For another example, the rack-level replica host machine 22-1 can instruct the existing host machine 34 to refuse model partition requests from the model server replica 26-1. In some instances, refusal of a model partition request may cause the model server replica 26-1 to automatically search for a new node host machine and then “discover” the rack-level node host machine 48-2 locally via the network switch 49. Alternatively, if refusal of a model partition request does not cause automatic host machine discovery, the rack-level replica host machine 22-1 can further instruct the existing host machine 34 to include information that identifies the rack-level node host machine 48-2 to the model server replica 26-1 when sending a refusal message for model partition requests (e.g., returning a refusal error message that includes an IP address, internal network identifier, etc. for the rack-level node host machine 48-2).

Once initialized, the local image registry mirrors 51 of the initializer nodes 50 can serve the model image partitions 32 to associated rack-level replica host machines 22. For example, the local image registry mirror 51-2 of the initializer node 50-2 can serve the model image partitions 32 to the rack-level replica host machines 22-1 and 22-2, while the local image registry mirror 51-1 of the initializer node 50-1 can serve the model image partitions 32 to the AZ-level replica host machines 22-3 and 22-4. In addition, the node host machines 48 can serve updates to the model image partitions 32 to their respective replica host machines 22. For example, the rack-level node host machine 48-2 can receive an update to a model partition of the model partitions 32 from the existing host machine 34. The node host machine can then update the local image registry mirror 51-2 to include the update to the model partition.

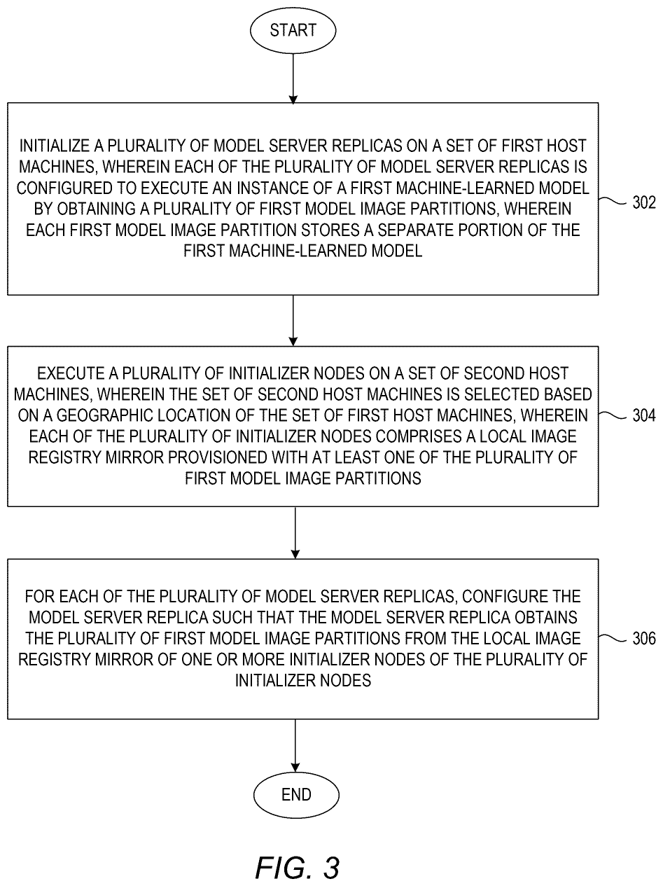

FIG. 3 is a flowchart illustrating operations performed by the computing system of FIG. 1 to implement a topology-aware multi-host model serving system with mirrored local image registries, according to one example. Elements of FIG. 1 are referenced in describing FIG. 3 for the sake of clarity. In FIG. 3, operations begin with a processor device of a computing device, computing system, network node, etc., such as the processor device(s) 14 of the computing system 12 of FIG. 1. The processor device(s) 14 are to initialize a plurality of model server replicas 26 on a set of first (i.e., replica) host machines 22, wherein the plurality of model server replicas 26 are each configured to execute an instance of a first machine-learned model 30 by obtaining a plurality of first model image partitions 32, wherein each of the first model image partitions 32 stores a separate portion of the first machine-learned model 30 (block 300). The processor device(s) 14 are further to execute a plurality of initializer nodes 50 on a set of second (i.e., node) host machines 48, wherein the set of second (i.e., node) host machines 48 is selected based on a geographic location of the set of first (i.e., replica) host machines 22, wherein each of the plurality of initializer nodes 50 comprises a local image registry mirror 51 provisioned with at least one of the plurality of first model image partitions 32 (block 302). The processor device(s) 14 are further to, for each of the plurality of model server replicas 26, configure the model server replica 26 such that the model server replica 26 obtains the plurality of first model image partitions 32 from the local image registry mirror 51 of one or more initializer nodes of the plurality of initializer nodes 50 (block 304).

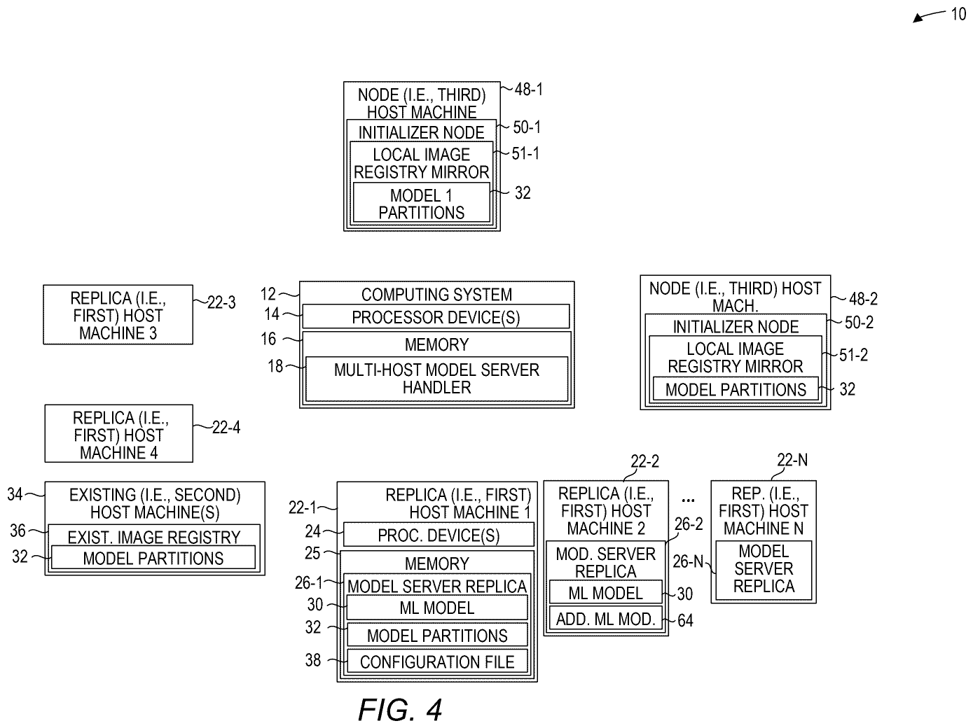

FIG. 4 is a block diagram of the computing system of FIG. 1 for a topology-aware multi-host model serving system with mirrored local image registries, according to one example. Elements of FIG. 1 are referenced in describing FIG. 4 for the sake of clarity. In the example of FIG. 4, the computing system 12 includes a memory 16 and processor device(s) 14 coupled to the memory 16. The processor device(s) 14 are to initialize a plurality of model server replicas 26 on a set of first (i.e., replica) host machines 22, wherein the plurality of model server replicas 26 are each configured to execute an instance of a first machine-learned model 30 by obtaining a plurality of first model image partitions 32, wherein each of the first model image partitions 32 stores a separate portion of the first machine-learned model 30. The processor device(s) 14 are further to execute a plurality of initializer nodes 50 on a set of second (i.e., node) host machines 48, wherein the set of second (i.e., node) host machines 48 is selected based on a geographic location of the set of first (i.e., replica) host machines 22, wherein each of the plurality of initializer nodes 50 comprises a local image registry mirror 51 provisioned with at least one of the plurality of first model image partitions 32. The processor device(s) 14 are further to, for each of the plurality of model server replicas 26, configure (e.g., modify the configuration file 38) of the model server replica 26 such that the model server replica 26 obtains the plurality of first model image partitions 32 from the local image registry mirror 51 of one or more initializer nodes of the plurality of initializer nodes 50.

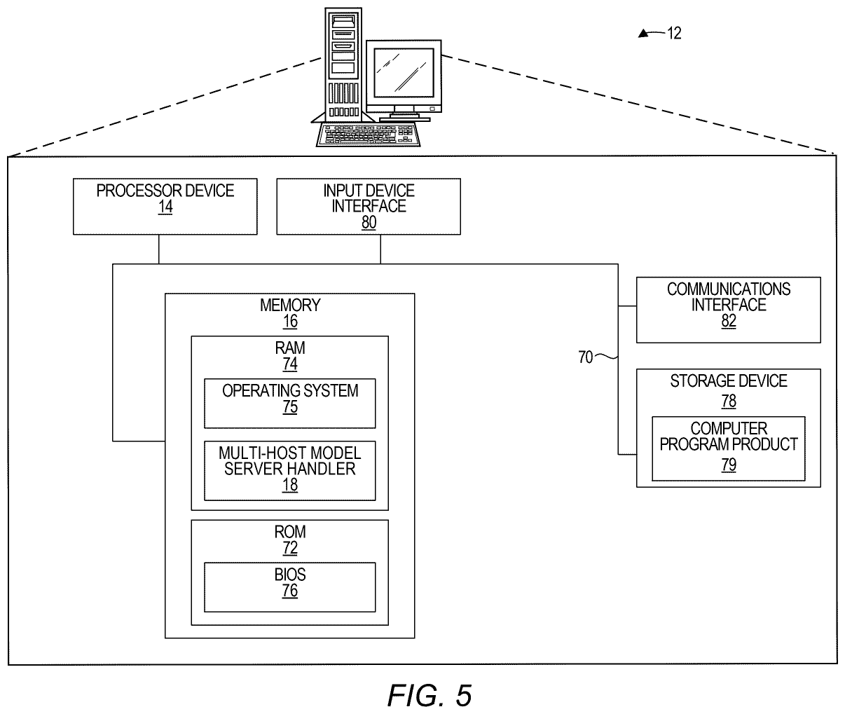

FIG. 5 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 70. The system bus 70 provides an interface for system components including, but not limited to, the memory 16 and the processor device(s) 14. The processor device(s) 14 can be any commercially available or proprietary processor.

The system bus 70 may be any of several types of bus structures that may further interconnect to a memory bus (with or without a memory controller), a peripheral bus, and/or a local bus using any of a variety of commercially available bus architectures. The memory 16 may include non-volatile memory 72 (e.g., read-only memory (ROM), erasable programmable read-only memory (EPROM), electrically erasable programmable read-only memory (EEPROM), etc.), and volatile memory 74 (e.g., random-access memory (RAM)). A basic input/output system (BIOS) 76 may be stored in the non-volatile memory 72 and can include the basic routines that help to transfer information between elements within the computing system 12. The volatile memory 74 may also include a high-speed RAM, such as static RAM, for caching data.

The computing system 12 may further include or be coupled to a non-transitory computer-readable storage medium such as the storage device 78, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 78 and other drives associated with computer-readable media and computer-usable media may provide non-volatile storage of data, data structures, computer-executable instructions, and the like.

A number of modules can be stored in the storage device 78 and in the volatile memory 74, including an operating system 75 and one or more program modules, such as the multi-host model server handler 18, which may implement the functionality described herein in whole or in part. All or a portion of the examples may be implemented as a computer program product 79 stored on a transitory or non-transitory computer-usable or computer-readable storage medium, such as the storage device 78, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the multi-host model server handler 18 in the volatile memory 74, may serve as a controller, or control system, for the computing system 12 that is to implement the functionality described herein.

Because the multi-host model server handler 18 is a component of the computing system 12, functionality implemented by the multi-host model server handler 18 may be attributed to the computing system 12 generally. Moreover, in examples where the multi-host model server handler 18 comprises software instructions that program the processor device(s) 14 to carry out functionality discussed herein, functionality implemented by the multi-host model server handler 18 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 80 that is coupled to the system bus 70 but can be connected by other interfaces such as a parallel port, an Institute of Electrical and Electronic Engineers (IEEE) 1394 serial port, a Universal Serial Bus (USB) port, an IR interface, and the like. The computing system 12 may also include a communications interface 82 suitable for communicating with a network as appropriate or desired. The computing system 12 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
initializing, by a computing system comprising one or more computing devices, a plurality of model server replicas on a set of first host machines, wherein each of the plurality of model server replicas is configured to execute an instance of a first machine-learned model by obtaining a plurality of first model image partitions, wherein each first model image partition stores a separate portion of the first machine-learned model;
executing a plurality of initializer nodes on a set of second host machines, wherein the set of second host machines is selected based on a geographic location of the set of first host machines, wherein each of the plurality of initializer nodes comprises a local image registry mirror provisioned with at least one of the plurality of first model image partitions; and
for each of the plurality of model server replicas, configuring the model server replica such that the model server replica obtains the plurality of first model image partitions from the local image registry mirror of one or more initializer nodes of the plurality of initializer nodes.

2. The method of claim 1, wherein executing the plurality of initializer nodes on the set of second host machines comprises:
identifying a rack-level subset of first host machines from the set of first host machines based on each of the rack-level subset of first host machines being connected to a particular network switch; and
responsive to identifying the rack-level subset of first host machines, executing a first initializer node of the plurality of initializer nodes on a rack-level second host machine of the set of second host machines, wherein the rack-level second host machine is connected to the particular network switch.

3. The method of claim 2, wherein executing the first initializer node of the plurality of initializer nodes on the rack-level second host machine of the set of second host machines further comprises:
provisioning the local image registry mirror of the first initializer node with the at least one of the plurality of first model image partitions.

4. The method of claim 1, wherein executing the plurality of initializer nodes on the set of second host machines comprises:
identifying an Availability Zone (AZ)-level subset of first host machines from the set of first host machines based on the AZ-level subset of first host machines being connected to a plurality of different network switches, each of the plurality of different network switches being located within a particular AZ; and
responsive to identifying the AZ-level subset of first host machines, selecting an AZ-level second host machine of the set of second host machines for execution of an initializer node of the plurality of initializer nodes, wherein the AZ-level second host machine is located within the particular AZ.

5. The method of claim 4, wherein configuring the model server replica comprises:
configuring a subset of model server replicas of the plurality of model server replicas hosted by the AZ-level subset of first host machines such that the subset of model server replicas obtains the plurality of first model image partitions from the local image registry mirror of the initializer node executed on the AZ-level second host machine.

6. The method of claim 4, wherein, prior to configuring each of the plurality of model server replicas, each of the plurality of model server replicas comprises a configuration file that configures the model server replica to obtain the plurality of first model image partitions from a plurality of existing image registries hosted by a set of third host machines; and
wherein the AZ-level second host machine of the set of second host machines is selected for execution of the initializer node of the plurality of initializer nodes based on:
a distance between the AZ-level second host machine and the set of first host machines; and
a distance between the AZ-level second host machine and the set of third host machines.

7. The method of claim 6, wherein selecting the AZ-level second host machine of the set of second host machines is further based on at least one of:
a bandwidth capacity of the AZ-level second host machine; or
a file size associated with the plurality of first model image partitions.

8. The method of claim 6, wherein configuring each of the plurality of model server replicas comprises:
for each of a subset of the plurality of model server replicas hosted by the AZ-level subset of first host machines:
modifying the configuration file that configures the model server replica such that the model server replica obtains the plurality of first model image partitions from the local image registry mirror of the initializer node executed on the AZ-level second host machine rather than the plurality of existing image registries hosted by the set of third host machines.

9. The method of claim 8, wherein provisioning the local image registry mirror of the first initializer node with the at least one of the plurality of first model image partitions further comprises:
determining that a first model server replica executed on a first host machine of the rack-level subset of first host machines is configured to execute an instance of a second machine-learned model by obtaining a plurality of second model image partitions; and
provisioning the local image registry mirror of the first initializer node with the plurality of second model image partitions.

10. A computing system comprising:
a memory; and
one or more processor devices coupled to the memory to:
initialize a plurality of model server replicas on a set of first host machines, wherein each of the plurality of model server replicas is configured to execute an instance of a first machine-learned model by obtaining a plurality of first model image partitions, wherein each first model image partition stores a separate portion of the first machine-learned model;
execute a plurality of initializer nodes on a set of second host machines, wherein the set of second host machines is selected based on a geographic location of the set of first host machines, wherein each of the plurality of initializer nodes comprises a local image registry mirror provisioned with at least one of the plurality of first model image partitions; and
for each of the plurality of model server replicas, configure the model server replica such that the model server replica obtains the plurality of first model image partitions from the local image registry mirror of one or more initializer nodes of the plurality of initializer nodes.

11. The computing system of claim 10, wherein, to execute the plurality of initializer nodes on the set of second host machines, the one or more processor devices are to:
identify a rack-level subset of first host machines from the set of first host machines based on each of the rack-level subset of first host machines being connected to a particular network switch; and
responsive to identifying the rack-level subset of first host machines, execute a first initializer node of the plurality of initializer nodes on a rack-level second host machine of the set of second host machines, wherein the rack-level second host machine is connected to the particular network switch.

12. The computing system of claim 10, wherein, to execute the plurality of initializer nodes on the set of second host machines, the one or more processor devices are to:
identify an Availability Zone (AZ)-level subset of first host machines from the set of first host machines based on the AZ-level subset of first host machines being connected to a plurality of different network switches, each of the plurality of different network switches being located within a particular AZ; and
responsive to identifying the AZ-level subset of first host machines, select an AZ-level second host machine of the set of second host machines, wherein the AZ-level second host machine is located within the particular AZ.

13. The computing system of claim 12, wherein, to configure the model server replica, the one or more processor devices are to:
configure a subset of model server replicas of the plurality of model server replicas hosted by the AZ-level subset of first host machines such that the subset of model server replicas obtains the plurality of first model image partitions from the local image registry mirror of the initializer node executed on the AZ-level second host machine.

14. The computing system of claim 12, wherein, prior to configuring the plurality of model server replicas, each of the plurality of model server replicas comprises a configuration file that configures the model server replica to obtain the plurality of first model image partitions from a plurality of existing image registries hosted by a set of third host machines; and
wherein the AZ-level second host machine of the set of second host machines is selected for execution of the initializer node of the plurality of initializer nodes based on:
a distance between the AZ-level second host machine and the set of first host machines; and
a distance between the AZ-level second host machine and the set of third host machines.

15. The computing system of claim 14, wherein the selection of the AZ-level second host machine of the set of second host machines is further based on at least one of:
a bandwidth capacity of the AZ-level second host machine; or
a file size associated with the plurality of first model image partitions.

16. The computing system of claim 14, wherein, to configure each of the plurality of model server replicas, the one or more processor devices are to, for each of a subset of the plurality of model server replicas hosted by the subset of AZ-level first host machines:
modify the configuration file of the model server replica such that the model server replica obtains the plurality of first model image partitions from the local image registry mirror of the initializer node executed on the AZ-level second host machine rather than the plurality of existing image registries hosted by the set of third host machines.

17. The computing system of claim 11, wherein, to execute the first initializer node of the plurality of initializer nodes on the rack-level second host machine of the set of second host machines, the one or more processor devices are further to:
provision the local image registry mirror of the first initializer node with the at least one of the plurality of first model image partitions.

18. The computing system of claim 17, wherein, to provision the local image registry mirror of the first initializer node with the plurality of first model image partitions, the one or more processor devices are further to:
determine that a first model server replica executed on a first host machine of the rack-level subset of first host machines is configured to execute an instance of a second machine-learned model by obtaining a plurality of second model image partitions; and
provision the local image registry mirror of the first initializer node with the plurality of second model image partitions.

19. A non-transitory computer-readable storage medium that includes executable instructions configured to cause one or more computing devices to:
initialize a plurality of model server replicas on a set of first host machines, wherein each of the plurality of model server replicas is configured to execute an instance of a first machine-learned model by obtaining a plurality of first model image partitions, wherein each first model image partition stores a separate portion of the first machine-learned model;
execute a plurality of initializer nodes on a set of second host machines, wherein the set of second host machines is selected based on a geographic location of the set of first host machines, wherein each of the plurality of initializer nodes comprises a local image registry mirror provisioned with at least one of the plurality of first model image partitions; and
for each of the plurality of model server replicas, configure the model server replica such that the model server replica obtains the plurality of first model image partitions from the local image registry mirror of one or more initializer nodes of the plurality of initializer nodes.

20. The non-transitory computer-readable storage medium of claim 19, wherein, to execute the plurality of initializer nodes on the set of second host machines, the one or more computing devices are to:
identify a rack-level subset of first host machines from the set of first host machines based on each of the rack-level subset of first host machines being connected to a particular network switch; and
responsive to identifying the rack-level subset of first host machines, execute a first initializer node of the plurality of initializer nodes on a rack-level second host machine of the set of second host machines, wherein the rack-level second host machine is connected to the particular network switch.
